(19) United States
(12) Patent Application Publication
(10) Pub. No.: US 2020/0314359 A1
(43) Pub. Date: Oct. 1, 2020

(54) NETWORK CAMERA WITH LOCAL CONTROL BUS AND THERMAL MONITORING SYSTEM INCLUDING NETWORKED CAMERAS

(71) Applicant: Seek Thermal, Inc., Goleta, CA (US)

(72) Inventors: Blake Henry, Santa Barbara, CA (US); William J. Parrish, Santa Barbara, CA (US); Kelly Brodbeck, Santa Barbara, CA (US)

(21) Appl. No.: 16/673,757

(22) Filed: Nov. 4, 2019

Related U.S. Application Data
(63) Continuation-in-part of application No. 16/562,252, filed on Sep. 5, 2019, now abandoned.
Application No. 16/562,252 is a continuation-in-part of application No. 16/191,295, filed on Nov. 14, 2018, now abandoned.
Application No. 16/191,295 is a continuation-in-part of application No. 15/342,469, filed on Nov. 3, 2016, now abandoned.
(60) Provisional application No. 62/588,117, filed on Nov. 17, 2017.
(60) Provisional application No. 62/259,519, filed on Nov. 24, 2015.

(51) Int. Cl. H04N 5/33; G06F 1/3209; H04N 7/18; H04N 5/232; H04L 29/08

(52) U.S. Cl. CPC H04N 5/332; G06F 1/3209; H04L 67/125; H04N 5/23206; H04N 7/181

(57) ABSTRACT

System or methods related to a thermal monitoring system including or interfaced to local intelligence and a network connection to network servers and in particular internet servers. The thermal monitoring system may include one or more visible light cameras, one or more thermal imagers, or both. At least some of the system components may have to operate in high ambient temperature environments, so those components are selected accordingly. The system may also include at least one visible camera disposed to view and obtain image data for gauges and other suitable sensor may be interfaced to the system controller and image and sensor data packaged are communicated to a remote server.

### INCORPORATION BY REFERENCE TO ANY PRIORITY APPLICATIONS

This application is a continuation-in-part of U.S. application Ser. No. 16/562,252, filed Sep. 5, 2019, entitled “NETWORK CAMERA WITH LOCAL CONTROL BUS AND THERMAL MONITORING SYSTEM INCLUDING NETWORKED CAMERAS,” which is a continuation-in-part of U.S. application Ser. No. 16/191,295, filed Nov. 14, 2018, entitled “NETWORK CAMERA WITH LOCAL CONTROL BUS,” which claims the benefit of U.S. Provisional Application Ser. No. 62/588,117, filed Nov. 17, 2017, entitled “NETWORK CAMERA WITH LOCAL CONTROL BUS.” This application is a continuation-in-part of U.S. application Ser. No. 15/342,469, filed Nov. 3, 2016, entitled “THERMAL IMAGING BASED MONITORING SYSTEM,” which claims the benefit of U.S. Provisional Application Ser. No. 62/259,519, filed Nov. 24, 2015, entitled “THERMAL IMAGING BASED MONITORING SYSTEM.” All of the above-referenced applications are hereby incorporated by reference in their entirety.

### BACKGROUND

### Field

The present application relates to cameras which are connected to a remote network server.

### Description of the Related Art

Networked smart camera modules and in particular dual spectrum cameras such as cameras with both a visible and thermal imager, are increasingly available in low cost compact forms suitable for a variety of monitoring and surveillance applications, with camera modules placed as desired and in communication with a networked server to form a monitoring system. Many applications for such systems may benefit from the camera modules with the ability to both observe and exert direct control over the local environment in a cost effective easy to implement manner.

### SUMMARY

Example embodiments described herein have innovative features, no single one of which is indispensable or solely responsible for their desirable attributes. Without limiting the scope of the claims, some of the advantageous features will now be summarized.

In some embodiments, system or methods may be provided related to a thermal monitoring system including or interfaced to local intelligence and a network connection to network servers such as internet servers. The thermal monitoring system may include one or more visible light cameras, one or more thermal imagers, or both. At least some of the system components may have to operate in high ambient temperature environments, so those components are selected accordingly. The system may also include at least one visible camera disposed to view and obtain image data for gauges and other suitable sensor may be interfaced to the system controller and image and sensor data packaged are communicated to a remote server.

In a first aspect, a thermal monitoring system may be provided, including at least one thermal camera; at least one local processor in communication with the thermal camera; at least one visible light camera configured to image gauges or other monitoring targets of interest, wherein the visible light camera is in communication with the local processor; and at least one network connection in communication with the processor and configured to communicate with a remote server; wherein the local processor and the remote server execute applications configured to share, between the local processor and the remote server, acquisition of camera video data from the cameras, and at least part of the system is configured to be operable at temperatures of at least one of 55° C. or lower, 65° C. or lower, 75° C. or lower, or 85° C. or lower.

In one embodiment of the first aspect, the network connection may include at least one of: a wired or wireless connection to a proprietary network; a wired connection to the internet; or a wireless connection to an internet bridge, wherein the internet bridge may include at least one of a wired connection to an internet gateway or a wireless connection to a router, the router being connected to an internet gateway. In another embodiment of the first aspect, the network connection may include a powered Ethernet connection.

In one embodiment of the first aspect, the system may include a standard local bus controller and bus interface including at least one of I²C, USB, PCI, or Firewire. In another embodiment of the first aspect, the network connection may include at least one of Bluetooth, Zigbee, wi-fi, cellular, satellite telephone, or optical. In one embodiment of the first aspect, the visible cameras and thermal cameras may be at least one of packaged and installed together, packaged and installed separately, or a combination thereof.

In another embodiment of the first aspect, the bus controller and the bus interface may be compatible with off-the-shelf devices including sensors and actuators. In one embodiment of the first aspect, the off-the shelf devices may include: visible cameras, accelerometers, magnetic sensors, linear actuators, motors, A/D converters, barometers, fluid level sensors, current/power sensors, linear position sensors and actuators, flow sensors, pressure sensors, gas sensors, optical motion sensors, temperature sensors, optical position sensors, vibration sensors, acoustic sensors, proximity sensors, audio alarms, visual alarms, visual status indicators, valve controllers, switch controllers, I/O breakout modules, power monitoring sensors, data load sensors, moisture sensors, humidity sensors, ultrasonic sensors, temperature reference sensors, oil quality sensors, and illumination controllers. The system may be capable of detecting supported devices connected to bus interface and automatically include data collected from them to the data set sent to the remote server.

In another embodiment of the first aspect, the operating temperature range may be achieved by a combination of packaging design, component selection and image processing. In one embodiment of the first aspect, devices interfaced to the local bus may be accessible from applications executing on at least one of the local processors or the server. In another embodiment of the first aspect, the system may be configured to monitor high power electrical components in at least one cabinet.

In one embodiment of the first aspect, higher temperature or high voltage components may be mounted in one part of an electrical cabinet and lower temperature or lower voltage components including gauges may be mounted in another electrically connected part of a cabinet, and the thermal camera may be mounted in one cabinet region and at least one visible camera may be mounted in another cabinet region. In another embodiment of the first aspect, the system may further include additional sensors including gas, smoke detectors, ultrasonic detectors and spark detectors or flash detectors.

In one embodiment of the first aspect, data collected by the local processor may be archived by the server in time windows, such that when a triggering event is detected in image data, information leading up to the trigger event is available. In another embodiment of the first aspect, the system may be powered independently of a local power source, including powered by battery or dedicated solar array. In one embodiment of the first aspect, the network connection may be independent of local connectivity, including connecting by system dedicated cell modem.

In another embodiment of the first aspect, the at least one visible light camera may be further configured to image equipment name plates. In one embodiment of the first aspect, at least one camera may be mountable by way of a magnetic or adhesive mount to minimize infrastructure changes. In another embodiment of the first aspect, rotational information relative to the cameras may be included in data provided to the server.

In a second aspect, a method may be provided for operating a monitoring system for electrical power distribution cabinets, the method including: mounting at least one thermal camera configured to operate at ambient temperature as high as at least one of 55° C., 65° C., or 75° C. in a position to view temperature critical components; mounting at least one visible light camera in a position to view gauges; interfacing the cameras to a local processor for at least one of image capture or image processing of the cameras' image data; connecting the local processor by way of a network interface to a remote network server; and reporting information related to camera image capture to the remote server.

In some embodiments a method for thermal monitoring of a FOV may be provided utilizing one or more networked interfaced, thermal imaging modules capable of operating in low power quiescent and active modes, including a shutter and a thermal sensor, including waking up the imaging module on at least one of a periodic time interval or in response to a wake-up command received over the network, wherein that interval is of sufficient time for the thermal sensor and shutter to reach thermal equilibrium, acquiring at least one of a frame of image data with the shutter closed, at least one frame with the shutter open, or both shutter open and shutter closed frames of at least a portion of the FOV, segmenting the image of the scene into at least two regions determining if intensity of region from a shutter open frame exceeds a predetermined difference from the intensity of the region with the shutter closed, returning to low power mode and repeating the above steps. In some embodiments, depending on if the region intensity differences exceed the predetermined threshold, at least one of sending at least one of an alert or region temperature data over the network interface, or sending a scene thermal image over the network interface.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 schematically illustrates a networked imaging system in accordance with an exemplary embodiment.

FIG. 2 schematically illustrates a networked imaging system including visible imaging and thermal imaging in accordance with an exemplary embodiment.

FIG. 3 illustrates example off-the-shelf devices compatible with an exemplary local bus.

FIG. 4 is a flow chart illustrating a method of operating a networked imaging system in accordance with an exemplary embodiment.

FIG. 5 illustrates the various system elements including server functions of an exemplary embodiment.

FIG. 6 illustrates an exemplary thermal monitoring system.

FIG. 7 illustrates an exemplary thermal monitoring system where at least one visible camera images gauges.

FIG. 8 illustrates an exemplary thermal monitoring system where at least one visible camera images gauges.

FIG. 9 illustrates an exemplary thermal monitoring system where at least one visible camera images gauges, and the system is suitable for high power electrical cabinet monitoring.

FIG. 10 is a flow chart of a method of operating the exemplary thermal monitoring system of FIG. 9.

FIG. 11 illustrates an exemplary monitoring system with a central controller/network interface and a plurality of imaging sensors, both visible and thermal, and other types of sensors.

FIGS. 12 and 13 are flow charts for alternative methods according to illustrative embodiments.

### DETAILED DESCRIPTION

Generally described, aspects of the present disclosure describe a camera module, which may in some embodiments take advantage of advances in miniaturization and cost, and may be a relatively small, inexpensive device with minimal power requirements. Advantageously, the module may have processing power and storage allowing it to engage in a variety of image acquisition, image processing, and other control and acquisition actions. The camera module may have a network interface which allows it to reside on a network, either local, directly to the Internet, or through a local bridge to the Internet. Along with network servers, the camera module can execute applications that make one or more network cameras a network-connected system for monitoring, such as industrial, electrical, or environmental monitoring, or surveillance. Such camera modules may be the basis of monitoring systems. If one or more of the cameras are thermal imagers, the monitoring system may be a thermal monitoring system, or a thermal condition monitoring system.

For some monitoring or surveillance applications, a camera module may observe conditions, which for a variety of safety or operational reasons may benefit from local response to information gathered by a camera module. For instance, the module may include a thermal imager as well as a visible imager. The module may be placed in an area where operating machinery is observed. If undesirable thermal conditions such as dangerous temperatures are observed by the module, or evidence of catastrophic equipment failure is observed and processed by the intelligent module, it may be desirable for the module itself to take direct local action rather than simply communicate the observed condition to the network server.

A degree of local control may be a desirable for an intelligent camera module. In addition to facilitating safety intervention, such a system can additionally or alternatively be programmed to provide process control, machine diagnostics, and/or predictive maintenance information. Such a system may also rely on machine learning software to enable its artificial intelligence such that all of the above functionalities (e.g., safety intervention, process control, diagnostics, and predictive maintenance) are enabled. However, in keeping with the concept of low cost and ease of implementation, it may be desirable to utilize the local module intelligence to control a standardized bus, such as USB, I²C, or the like. Such a local control bus may be advantageous as an array of compatible devices are available off-the-shelf, as well as easy to implement software drivers for these compatible devices. Adding a standard local bus to a camera module may provide direct access to a range of sensors and actuators, enabling actions such as local audio and/or visual alarms, direct control of shut off or turn on of equipment and/or safety equipment, and the like. Advantageously, such local control can be initiated directly through the module by the server, or if desired or necessary, directly by the module local processor. The elements of network connectivity, local intelligence and a local control bus, may provide an extremely powerful system for monitoring and surveillance with an enhanced level of safety and operational efficiency for the environments in which the camera module systems are utilized. It is also possible to utilize a combination of local and/or remote, server-based analytical techniques including but not limited to machine learning, artificial intelligence, motion tracking and, face recognition to trigger local configuration, data-acquisition, and/or control.

The camera modules, and/or imaging or monitoring systems including camera elements, may include local processor systems which in turn may include computer methods including programs or applications or digital logic methods and may be implemented using any of a variety of analog and/or digital discrete circuit components (transistors, resistors, capacitors, inductors, diodes, etc.), programmable logic, microprocessors, microcontrollers, application-specific integrated circuits, or other circuit elements. A memory may be configured to store computer programs and may be implemented along with discrete circuit components to carry out one or more of the processes described herein. The modules may include one or more imagers including imaging sensors which may be a Focal Plane Array (FPA), which may be part of a camera core for a visible, thermal, or other imaging device. Some processing and memory components may be included in the camera module and others may reside on other separate computerized devices including other modules, smart phones, tablets and computers or any combination thereof. In other embodiments some processing and memory elements may be implemented using programmable logic, such as an FPGA, which are part of the core, module, or camera system. The modules and the computerized devices may communicate over a network, including wireless networks.

In some embodiments, image data may be provided by a thermal imaging sensor, which may include a Focal Plane Array (FPA) imaging sensor. An example of such a system is an infrared (IR) camera core, including an IR FPA and associated optics and electronics.

An FPA, visible, thermal or other, typically includes a two-dimensional array of pixels including X by Y photodetectors, which can provide a two-dimensional image of a scene. For imaging purposes, image frames, typically data from all or some of the detectors (frame or subframe), up to X*Y pixels per frame, are produced by the FPA, with each successive frame containing data from the array captured, and typically converted from analog to digital form, in successive time windows. Thus, a frame (or subframe) of data delivered by the FPA will consist of a number of digital words, representing each pixel in the image, e.g., data from each detector. These digital words are usually the length of the analog to digital (A/D) conversion process, for example if the pixel data is converted with a 14-bit A/D, the pixel words are 14 bits in length, and there would be 16384 (2¹⁴) counts per word. For an IR camera used as a thermal imaging system, these words may correspond to a map of intensity of radiation in a scene measured by each pixel in the array. The intensity per pixel for a micro-bolometer type of photodetector IR FPA, for example, usually corresponds to the temperature of the corresponding part of the scene, with lower values corresponding to colder regions and higher values to hotter regions. It may be desirable to display this data on a visual display as an image of relative temperature vs position, or otherwise process and use the temperature information.

Each pixel in a thermal FPA may include the radiation detector itself, which for an IR imaging array may generate relatively small signals in response to the detected radiation. Pixels may include interface circuitry including resistor networks, transistors, and capacitors on a Readout Integrated Circuit (ROIC) that may be directly interfaced to the array of detectors. For instance, a microbolometer detector array, which is a MEMS (Microelectrical Mechanical System) construct may be manufactured using a MEMS process building up the microbolometers onto an ROIC which is fabricated using electronic circuit fabrication techniques. When complete the ROIC with the micro-bolometers integrated onto it combine to form an FPA.

Visible imaging sensors are more common and familiar to camera designers and will not be described in detail here. Small, low power, high performance visible imagers such as those found in smartphones and tablets for instance would be a suitable choice as imagers for a low-cost camera module. In some embodiments, other types of visible imagers may be combined with thermal cameras, local sensor/actuator devices, processing modules, and/or network connectivity to create networked monitoring systems.

A camera module/monitoring system may be formed from one or more FPA's, with associated electronics and optics, processing logic, and a wireless interface. A monitoring system may be formed including one or more such cameras along with one or more computerized devices acting as servers on a network executing suitable programs or applications and/or digital logic and interfaced to the modules across one or more wired or wireless networks.

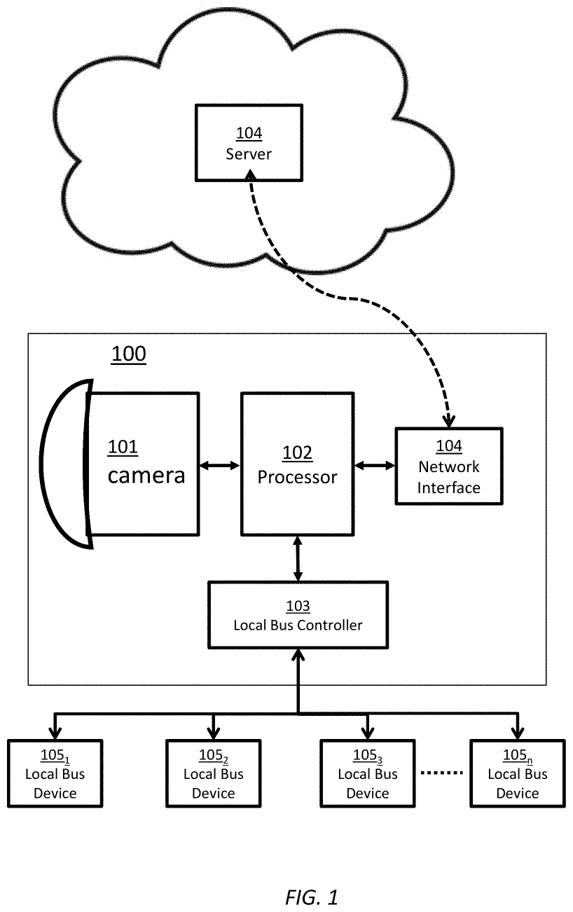

Referring to FIG. 1, a general block diagram of an illustrative embodiment of a camera module 100 is shown. Camera module 100 is in communication with a processor 102. Processor 102 is in communication with a network interface 104 and a local standardized bus controller 103. Although the elements are shown separately, in some embodiments they may be executed in software within the processor as opposed to separate physical entities. As described in greater detail below, the various elements described herein may reside in one module including one or more cameras, or may be distributed across a variety of elements to form a monitoring system.

Processor 102 may be functionally distributed over multiple elements, such as microprocessors, FPGA's, etc., each handling a different portion of the image processing, sequencing, and communication tasks.

To form a system, camera module 100 is networked to one or more servers 104a, which may reside on a local network and/or the Internet. The network interface may be wired or wireless. Example interfaces include Bluetooth, Zigbee, wi-fi, cellular, satellite telephone, optical, etc., or any combination. Wired interfaces include Ethernet, USB, Firewire, and others. The module may also connect to a broader network through a local bridge, such as a Wi-Fi router or other network bridge. In a particular embodiment, the network connection may be powered Ethernet, and the module may be powered directly from the network connector. Powered Ethernet may support a variety of power options, including the ability to add power as needed for high power items such as visible light sources (e.g., a flash associated with a visible light camera or a visible illuminator).

In some embodiments, the camera module 100 may be battery powered, or it may derive power from its installation other than through the network connection. A battery powered module 100 with a wireless network interface may be advantageous, as it allows for modules to be placed in a space with minimal or no infrastructure changes to the environment, by simply attaching the modules through a variety of simple means, where desired, with no need for any additional power, wiring, or other infrastructure support. Powered Ethernet is also common, and unpowered Ethernet, which is ubiquitous, may be easily converted to powered Ethernet with power modules which are easy to install. Thus, such camera modules or systems in many forms may be conveniently installed in an existing environment with little to no site preparation or modification. For example, many industrial installations such as high power electrical cabinets for transformers and the like already have electrical conduit access. Thus, it may be beneficial for some use cases if the module/system components can be mechanically installed with no modifications to the existing infrastructure. Convenient mechanical mounting provisions such as magnetic or adhesive mounting elements may be appropriate. Similarly, it may be advantageous to make the monitoring systems independent of local power and connectivity, both of which may be affected by the very things the systems are supposed to monitor. For instance, a failed or failing transformer may affect local power availability which in turn may affect network connectivity. System dedicated power (e.g., battery, solar, etc.) and system dedicated connectivity such as system dedicated cell modems, may be beneficial for many uses as well.

The local device interface 103 (such as a local bus controller) can be a standard bus with a large selection of compatible devices as well as available software drivers for the devices. The standard local bus may include, I²C, USB, PCI, Firewire, or others. As shown a plurality of local devices 105₁, 105₂, 105₃ . . . 105ₙ may reside on the bus.

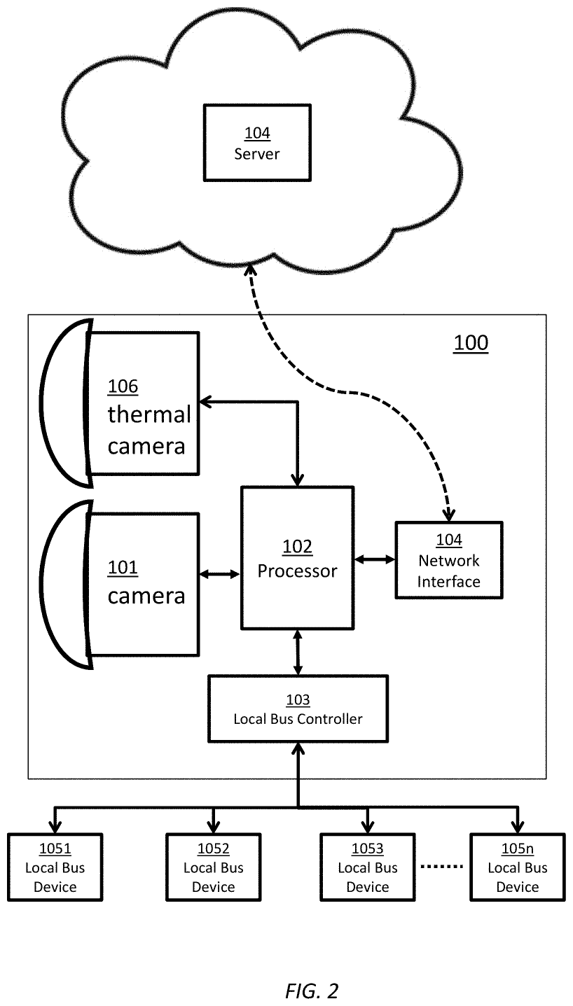

FIG. 2 illustrates a system similar to the system of FIG. 1. In the system of FIG. 2, the camera module 100 is a dual imaging system including a thermal camera 106. Additionally, any one or combination of imaging types are possible.

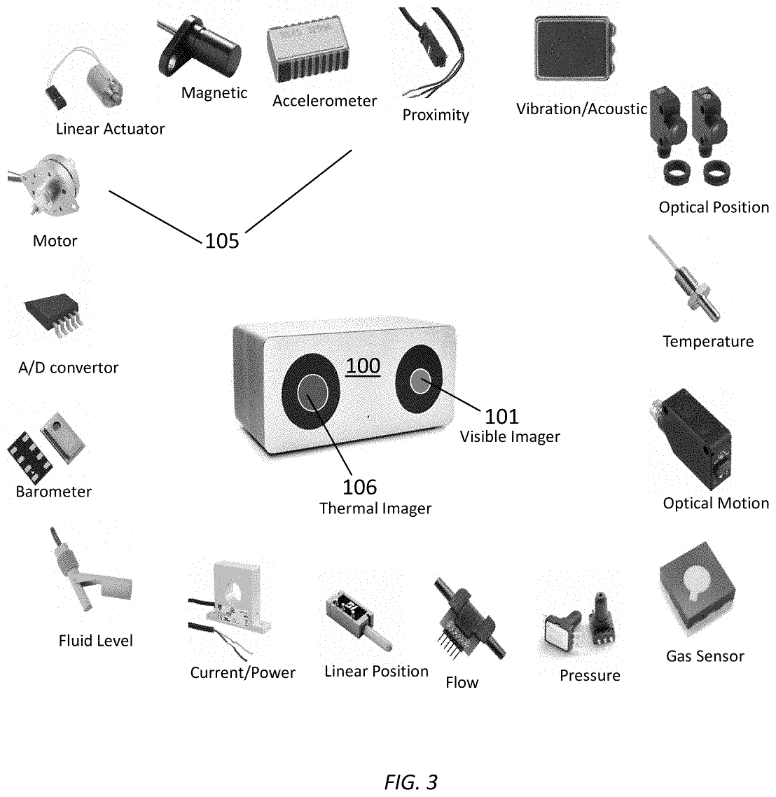

FIG. 3 illustrates a module 100 with both a thermal imager 106 and a visible imager 101. An assortment of devices available in particular on the I²C bus are shown. Other buses have similar device compatibility Devices suitable for monitoring and surveillance applications may include visible cameras, accelerometers, magnetic sensors, linear actuators, motors, A/D converters, barometers, fluid level sensors, current/power sensors, linear position sensors and actuators, flow sensors, pressure sensors, gas sensors, optical motion sensors, temperature sensors, optical position sensors, vibration/acoustic sensors, proximity sensors, audio alarms, visual alarms, visual status indicators, valve controllers, switch controllers, I/O breakout modules, illumination controllers, and others. Any or all of these may be available on the I²C bus. I²C may be advantageous due to its simplicity and the large number of very low cost compatible devices, some of which may cost just a few dollars or less, available device drivers, and industrial suitability of many of the devices. For many applications, e.g., closing valves, turning on warning lights, monitoring local humidity, and the like, high bus speeds such as can be achieved with buses like USB may not be critical, and relatively low speed busses like I²C may be perfectly suitable. However, other local buses, digital interfaces, and/or networked local devices may also be suitable.

In one example, the camera module 100 includes thermal imaging, is networked through powered Ethernet, and includes and acts as an I²C master. This module can be compact and inexpensive, utilizing a modern low cost microbolometer thermal imager, and is very easy to install and connect to in most industrial environments. For example as a monitor in a machinery room environment, the modules could be placed to observe various machines, piping and electrical cabinets/wiring, and the like. Off-the-shelf bus compatible valves, electrical switches, and visible/audio alarms could be connected to the bus. If a dangerous temperature condition is observed and captured by the camera module, it could directly initiate shut-off and local alarm actions, either under its own processor control or by the server through the camera module. The result is the camera module may serve as both watchdog and industrial controller, and by way of the standard local bus accomplishes both functions in a cost effective, easy to implement manner.

Other examples include intruder alert and/or interdiction, electrical cabinet monitoring, and many other applications where the image acquisition and analysis resides in one unit with standardized local control. Gas detectors, smoke alarms and the like are also possible local devices. The local bus may also supply power for connected devices. The system may automatically configure and report data from supported connected devices.

In some embodiments, the server may be remote and may be reachable over a network. In some embodiments, the camera modules/monitoring systems can be configured to report to and receive instructions from a cloud based server. The use of remote and/or cloud based servers may advantageously allow for monitoring systems anywhere in the world to be accessed from anywhere in the world. It would also allow for use of the modules/systems to be handled as a subscription service where the modules report to the cloud, data from multiple installations is handled at the cloud level and deviations are reported over various networks, such as email alerts, text messages, and the like.

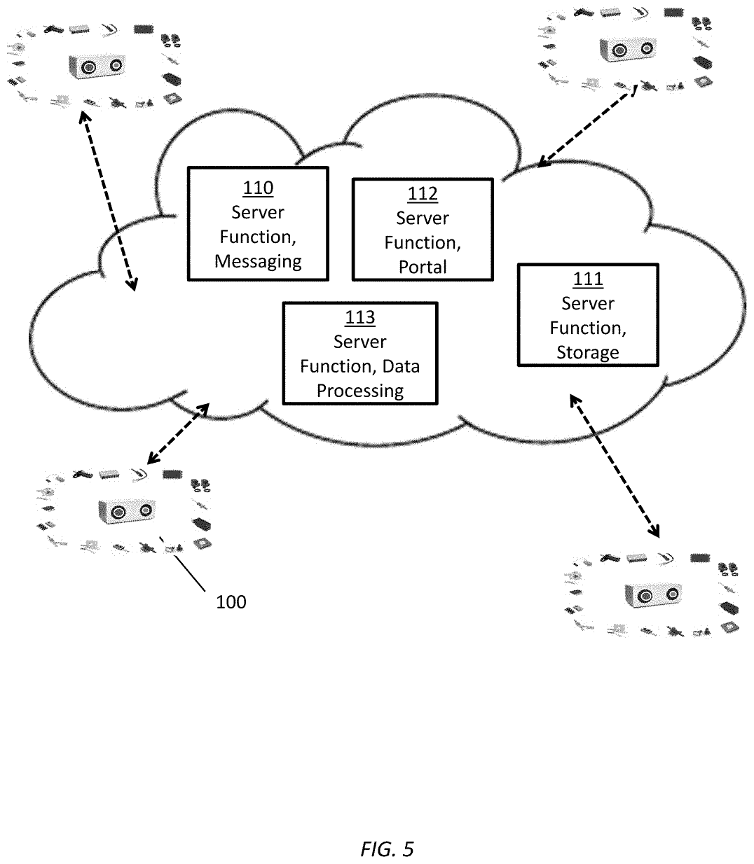

Such a system is shown in FIG. 5 where modules 100 with associated local devices interface over a network to network servers, which implement the various system functions 110 to 113.

Any physical layer may be used to access the network, including wi-fi, Ethernet, local networks such as Bluetooth, Zigbee and the like, cellular communication, microwave communication, IR communication, satellite phone, and others. The connection can be direct to the network, or through a local bridge or relay, as long as each module has a gateway to the network. The network may be proprietary network, but for many embodiments it is envisioned that the network will be the internet. The system controller functions described above may be apportioned across one or more servers implementing server functions.

In some embodiments, camera modules/monitoring systems belonging to individual users installed at a variety of sites and/or locations may all interface to the server based control system. Each user may access their individual installations and the data acquired from their monitors through an account based system.

Example server functions are shown in FIG. 5. Messaging 110 handles system communication and commands, identifying each system on the network and directing two-way messaging between the system, the system owner, and the other server functions. System data acquired may be stored on the network (e.g., cloud storage) allowing for the ability to store data representing long periods of time. Such long-term storage and access allows for the possibility of identifying trends and patterns, and in particular thermal patterns that indicate potential failure or other abnormal condition of an item the monitors are observing. In some embodiments, the system can be configured to observe and correlate thermal patterns for similar devices from multiple users to build up learning of thermal signatures and patterns that correlate to failure conditions, which may benefit all users of the system.

Data processing 113 may also take place at the server level. In some embodiments, data processing 113 may be distributed over some or all monitors interfaced to the network.

A portal 112 can serve as a user interface and may allow for set-up and access to data for users, including scripts or drivers for the local bus devices. For example, the portal may be where the user can identify the location of each component in an installation, set up parameters such as image regions and thresholds for each region, implement trending routines, and/or define protocols for data storage, processing, and/or reporting (e.g., what kind of data such as region temperature, whole images or real time imaging happens in response to specified conditions). The portal may also allow the user to specify how notifications of alarm or other conditions of interest will be communicated, and/or under what conditions the camera module/monitoring system will take action locally. Having the system controller functionality at the internet level offers a wide variety of communications possibilities. For example, emails, text messages, and phone calls are all possible as well as communication to any networked entity such as user on-site automation (e.g., factory controllers or individual networked devices). It is possible that if an over-temperature condition is observed for a piece of networked equipment (e.g., process equipment, motor, pump, or many other equipment types), a text message could be sent to appropriate users, a factory controller could be notified, and/or the individual device's warning system (e.g., Christmas tree lighting, audio alarm, etc.) could be activated. In some embodiments, the system may be configured to act to perform these actions through local bus connected devices either directly or originating at the server and passed through to the local bus. All of the set-up can be customized and personalized on a per module basis.

For many applications, critical events that trigger communications to the server may be analyzed better if data previous to the event is available. Thus, data reporting may be flexible and may include a combination of previous and current data.

Also, cameras may not necessarily be used solely in fixed installations. Thermal monitoring may apply to moving installations such as vehicles (cars, trucks aircraft, etc.) or large mobile equipment such as construction or mining vehicles, or be transported, e.g., mounted to vehicles or carried, to observation location areas. Thus, a GPS device may also be advantageously included in a camera module.

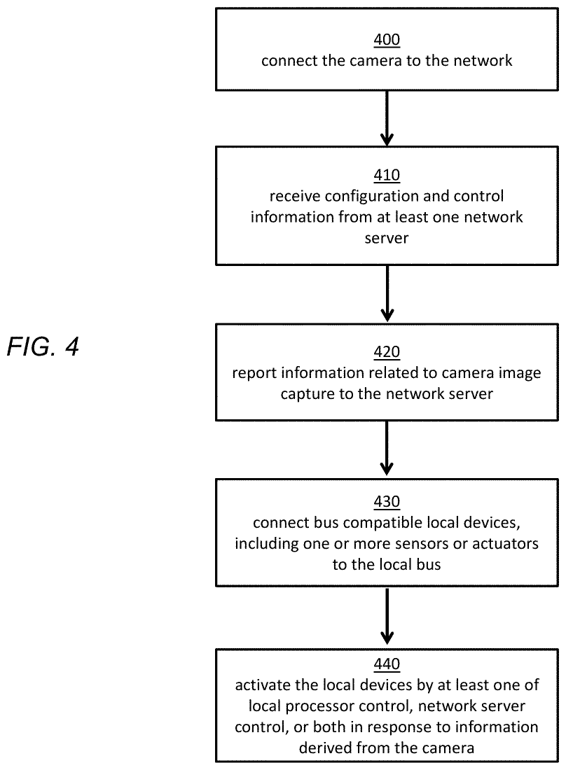

An example method utilizing a camera module of the type disclosed herein is shown in FIG. 4. In step 400 the camera module is connected to the network. This could be a local network and/or the Internet, a wired or wireless connection and either direct or through a bridge or gateway device such as a Wi-Fi router connected to network modem.

In step 410 configuration and control information is received from one or more network servers. This configuration information could relate to camera image acquisition parameter for example such as set-up of temperature thresholds if the camera has thermal imaging capability.

In step 420 information related to camera image acquisition may be reported to the servers. For example motion detected analyzed as an intruder, other pattern related discrepancies are the type of results an intelligent camera module can obtain from acquired and processed image data.

In step 430 local bus compatible devices including one or more sensors and actuators are connected to the camera local standard bus. Selection of a suitable local bus for the camera module may provide for a large number of useful devices that can quickly and easily integrated from both a hardware and software point of view.

In step 440 the local bus devices are activated by the camera processor, the servers or both in response to image information derived from the camera. For instance a dangerously high temperature detected by a thermal imaging camera could trigger the local activation of shut-off switches/valves, warning signal indicators, and the like all from local bus compatible devices hooked up to the module.

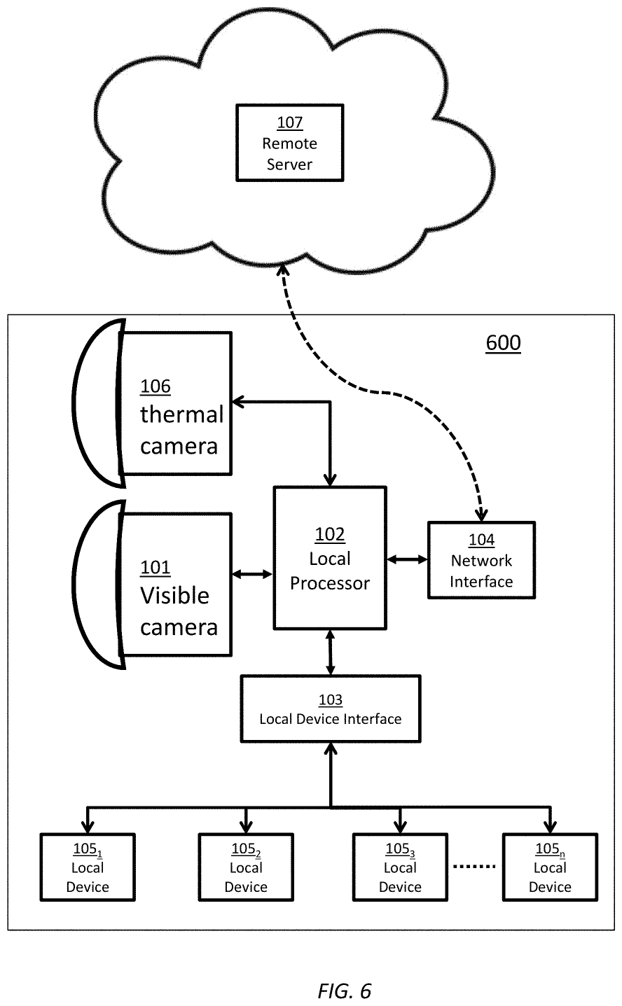

FIG. 6 illustrates an example thermal monitoring system 600. As opposed to the modules describe above, the system elements may or may not be resident in one unit but may be allocated and disposed as makes the most sense for a given application. It is envisioned that system 600 may include one or more cameras including at least one each of a thermal camera 106 and a visible camera 101. These cameras may be interfaced to a local processor 102, either directly or through a local device interface 103, of which one possible example is a standard bus controller as described above. Various local devices 105n may be interfaced through the local device interface 103. Data from imaging elements as well as other devices may be acquired, processed to a desired level, organized and communicated through a suitable network interface 104 as described above to remote server(s) 104, which may also serve as a controller and data center as described above.

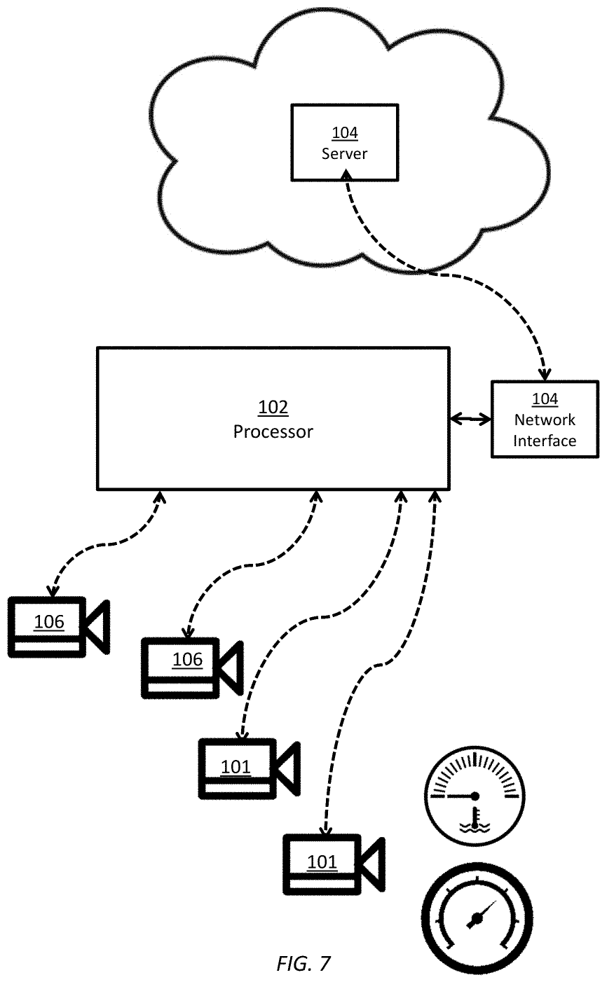

FIG. 7 illustrates an example monitoring system suitable for certain types of industrial applications such as transformer cabinet monitoring. Such a system configuration may also be applicable to any number of other applications such as switchgear, utility scale photovoltaic inverters, refining operations, electric motor monitoring, etc. Many industrial systems are still produced with gauges such as temperature gauges, pressure gauges, and the like. Although such gauges are often at remote locations and/or behind locked cabinets, they still may need to be read directly by service personnel. A network connected thermal monitoring system may require significant local processing power simply to acquire and perform signal processing for thermal images. Moreover, the temperature critical components that a thermal camera 106 is best suited to observe are usually in proximity to less temperature critical elements such as gauges. For example, one common arrangement is to place the hot elements and the less hot elements in two adjacent or nearby cabinets, or parts of cabinets, the cabinets each having electrical conduit access. Some or all cabinet areas may be at elevated temperatures, and the elements may be grouped by high voltage vs. low voltage. For example, putting the gauges, an oil analyzer, and/or fuses in the low voltage cabinet enables the door to be opened for reading of the instruments, while the high voltage cabinet or section may not be able to be opened without de-energizing the equipment which is both expensive and time consuming. Moreover, the high voltage section tends to be hotter than the low voltage sections. Thus, industrial operators may justify the effort of placing a networked thermal camera in view of certain elements, due to the critical nature of the thermal data justifying the expense. Adding a visible camera disposed to view elements such and gauges, equipment name plates and the like, and forming a high capability monitoring system is both possible and beneficial. In some implementations, visible gauge monitoring alone may not justify the need for the camera as well as the processing and networking capability. However, the decision to install thermal imaging may enable other visible light monitoring that might not by itself overcome the barriers to entry. An illumination capability (near IR or LED flash for example) may also be included so the visible image is appropriately illuminated for viewing.

Allowing remote viewing of gauges would be highly beneficial to operators of industrial facilities. Gauges may be read automatically via image acquisition, enabling gauge based triggering of alarms, local actions, etc., with the local processing available for the thermal acquisition. A variety of techniques may be used to capture the gauge reading and convert it to digital data. Pattern recognition techniques may be used for such applications. More sophisticated techniques involving machine learning and other machine intelligence techniques are also contemplated.

For such installations, all or some of the monitoring systems may have to operate at high ambient temperatures. For the transformer cabinet example, the thermal camera may be best mounted in a hotter high voltage cabinet or cabinet section, and depending on the system configuration, some or all of the processing and connectivity may be co-packaged with the camera. Many industrial monitoring applications may expose system components to ambient temperatures of at least 55° C., and maybe as high as 65 or even 75-85° C. Therefore, thermal monitoring systems may need to be designed for at least part of the system to be operable at high ambient temperature. Such operation may difficult to achieve, particularly for thermal cameras. Industrial or military grade components may be necessary, and well thought out thermal management in the form of case design heat sinking and the like may be beneficial. Additionally, special signal/image processing for high ambient thermal camera operation may be required. For example, Texas Instruments (TI) and NXP make processors and supporting components that are operable at extended temperature ranges. TI's Sitara ARM processors for instance are available in versions that operate at up to 85° C. in some versions and as high as 125° C. in the most extended version. Other sources such as Octavo provide fully configured computers on a chip, e.g., processor, memory and I/O based on the Sitara line where the computer product is operable up to 80° C. Such choices enable the high temperature range operation required for high power cabinet applications while maintaining the processing power needed to process thermal image data and handle network communications as well as sensor control and data acquisition.

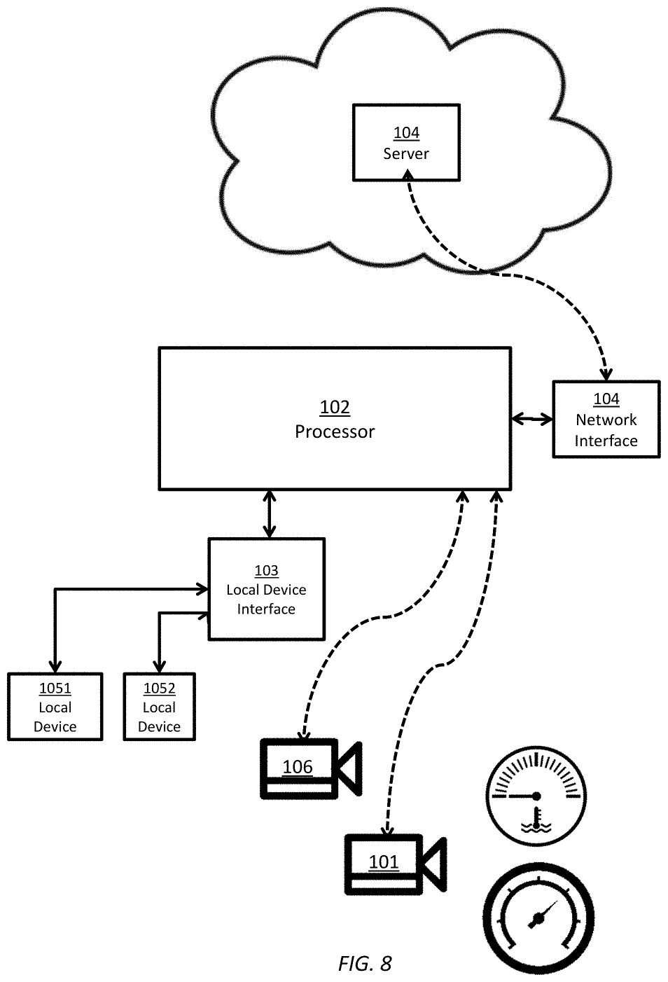

As shown in FIG. 8, such thermal monitoring systems may also benefit from additional local devices 1051, 1052, etc., in addition to thermal and visible imaging.

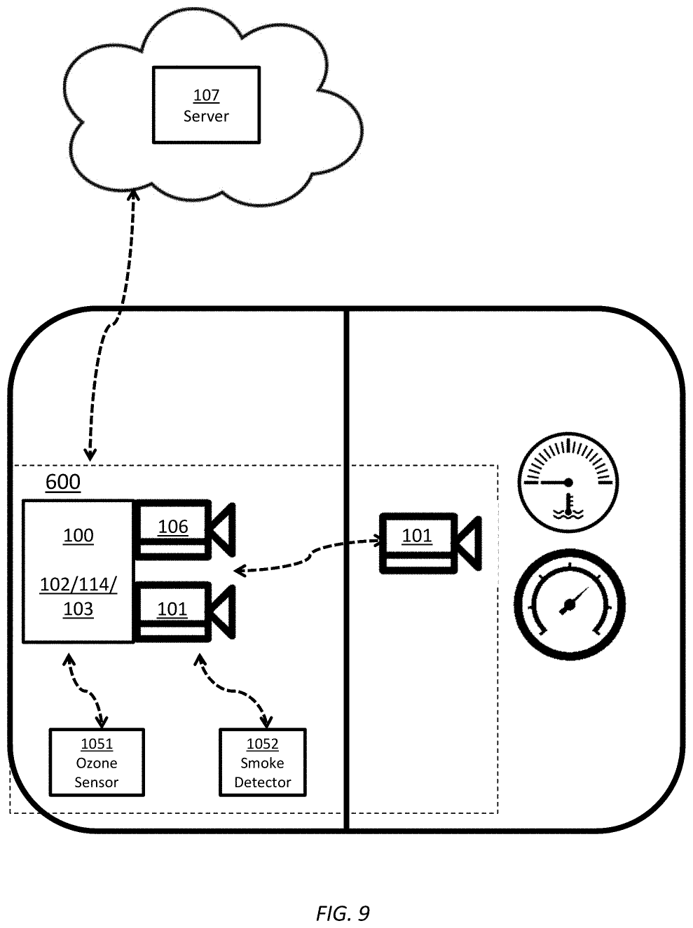

FIG. 9 illustrates a particular thermal monitor system 600 embodiment for a two section transformer cabinet. In this embodiment, a thermal camera 106, a visible light camera 101, processing 102, network 104, and local device interface 103 functions are packaged in one module 100 which is mounted in the high voltage side of the cabinet. Also connected on the high voltage side are additional local devices including an ozone sensor 1051 and a smoke detector 1052. Another visible light camera 101 is mounted in view of gauges in the low voltage side of the cabinet, and this camera is connected to processor 102 either directly or through local device interface 103. Data packages containing data from all sensors and imagers are organized and presented to the server 107 over the network. In some embodiments, gauge images are made available over the network directly if requested. Since image skew amongst different imagers can be confusing with regard to alignment of gauges, it may be beneficial in some embodiments to include relative orientation (e.g., rotation) information about the imagers in the data packages.

It should be noted that the packaging and relative placement of the various elements illustrated in FIG. 9 is representative of a particular implementation but many other arrangements, including different numbers and types of sensors and other components, are possible.

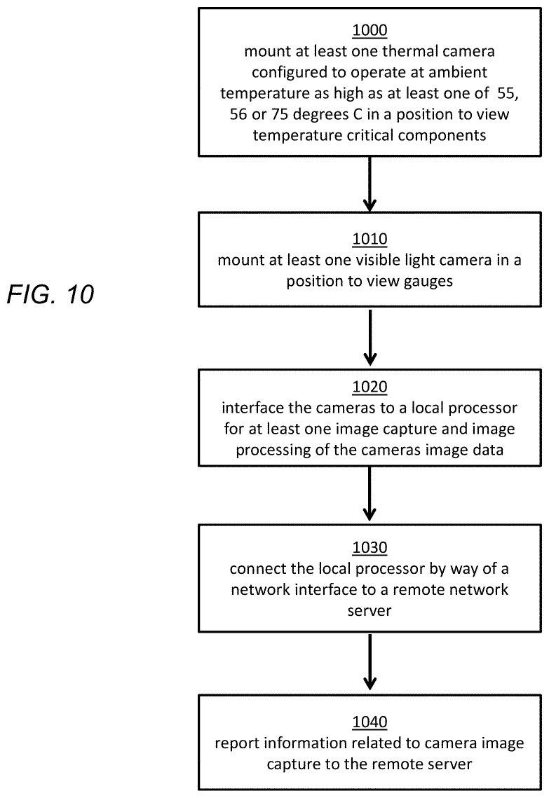

FIG. 10 is a flow chart illustrating an example method for operating the system of FIG. 9.

In step 1000, mount at least one thermal camera configured to operate at ambient temperature as high as at least one of 55° C., 65° C., 75° C. or 85° C. in a position to view temperature critical components. Depending on the actual installation, various mounting, optics, and alignment options are possible for the thermal camera.

In step 1010, mount at least one visible light camera in a position to view gauges. This may correspond to a low voltage cabinet compartment of the monitored equipment. Other reading functions, such as transformer name plate information which may not otherwise be available to operators, may be viewed. Although automated reading is possible, direct imaging may also be useful in and of itself. Again, depending on the actual installation, various mounting, optics, and alignment options are possible for the visible camera. An illumination capability (near IR or LED flash for example) may also be included so the visible image is appropriately illuminated for viewing.

In step 1020, interface the cameras to a local processor for at least one of image capture or image processing of the cameras' image data. Other sensors (gas, particulate, etc,) may also be connected.

In step 1030, connect the local processor by way of a network interface to a remote network server. As described above, a variety of ways to do this are possible.

In step 1040, report information related to camera image capture to the remote server. As described above, various centralized control provisioning and other function may take place at the server level.

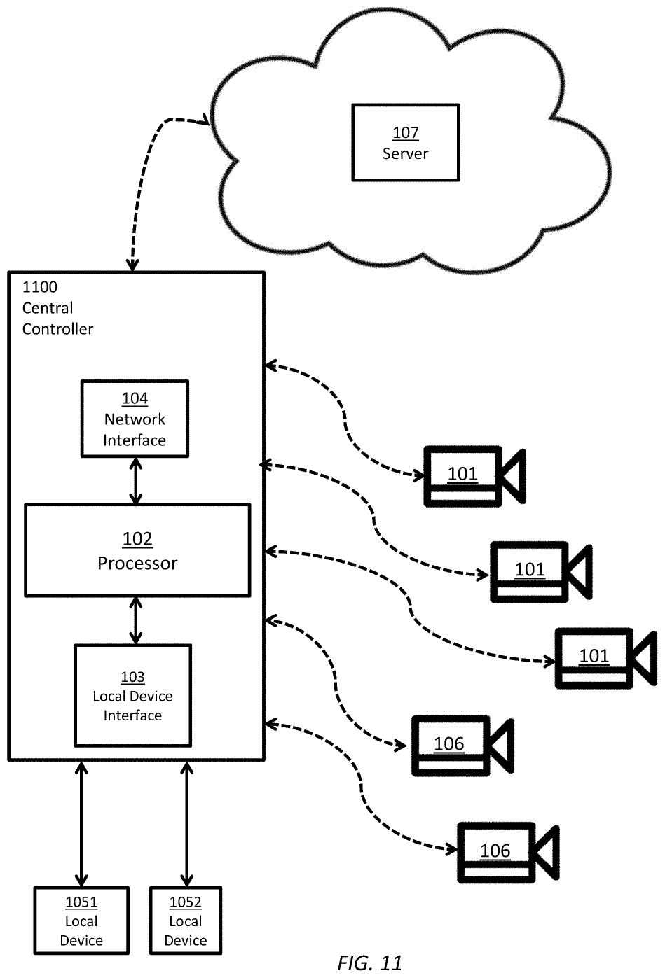

A further example monitoring system configuration is shown in FIG. 11. For the embodiment of FIG. 11, it is contemplated that many sensors/actuators, both imaging and other types, may all interface to a single processing/network gateway device, shown as central controller 1100. This type of scenario may be advantageous when large numbers of locations must be monitored, but the data density and/or frequency of acquisition is low enough that dedicated processing/communication is not required for individual or small groups of sensors but rather may distributed amongst large numbers of sensors. An example of such a monitoring application is high power industrial switch gear cabinets for electrical power applications where hundreds of cabinets may require monitoring, but only need to acquire and report information at low rates, such as one image and sensor update per day for example.

Such an application allows for simpler, less expensive sensors. For example, very inexpensive thermal imagers are available from Seek Thermal, Inc., the applicant of the present application, called microcores. These microcores, which may be interfaced to a high capability processor, can be far less expensive than fully featured standalone thermal imagers. Thus, a configuration such as illustrated in FIG. 11 may include a central controller 1100 with a processor 102, a network interface 104, and a local device interface 103 for local device control. Such a unit could interface to a plurality of simple thermal imaging units 106, visible light cameras 101, and/or local sensors or actuators 1051, 1052, etc. Some of these interfaced devices may be built into the control unit, but in this multisensor scenario, most or all can be located where needed and interfaced to the unit through a variety of suitable wired or wireless interfaces. In some implementations, even hundreds of devices 101, 106, 1051, 1052 reporting to one central controller 1100 may be practical for low data reporting applications. The simple sensors can deliver raw data, and the central controller 1100 can process, organize, and communicate results with the network interface 104, as well as receive control and configuration information from the cloud for all of the interfaced sensors. Although FIG. 11 depicts a system including the central controller 1100, two types of imaging sensors and other local actuators and sensors, it will be understood that the system of FIG. 11 may be implemented as a modular system, and that not all of these types of devices would necessarily be present in all applications; various combinations and/or subcombinations of the illustrated components are possible without departing from the spirit or scope of the present disclosure.

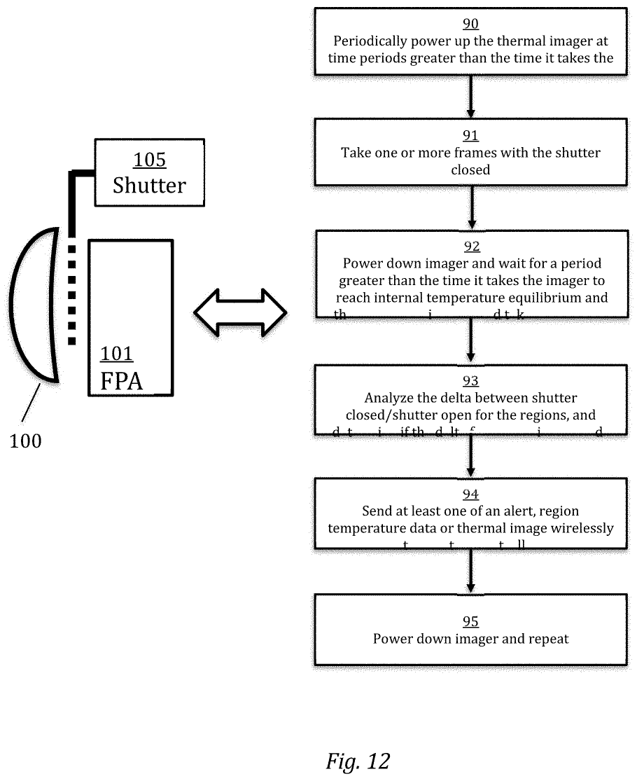

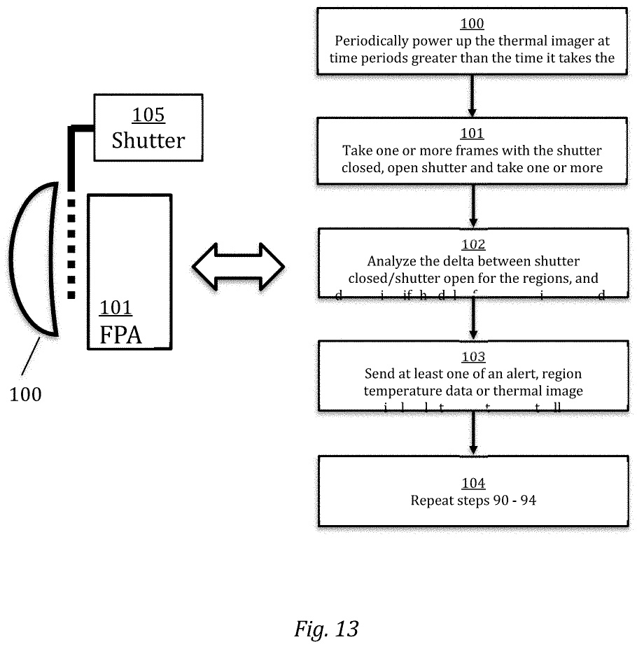

FIGS. 12 and 13 illustrate a mode of operation for systems with a shutter 105 that may allow for even lower power consumption for some types of thermal imagers. Performing accurate thermography usually entails that an FPA be powered up and imaging for a multitude of frames to allow for thermal stabilization and to perform all of the corrections and other operations necessary for accurate thermal data. Thus determining actual temperatures requires that a module operate for 10's of seconds or more each wake period. However, in powered down mode, after a sufficient time the module will come to near ambient temperature, where the FPA and shutter are in thermal equilibrium with each other and the surrounding environment. Thus if a frame of data is taken with the shutter closed immediately upon power up, the data will represent each pixel's equivalent of room temperature. If a single frame is taken shutter open, then the delta between the shutter closed and open frame for each pixel is the delta between the scene temperature and room temperature. These deltas may be used as thresholds without actually knowing the temperature accurately simply by comparing to baseline scenes where the scene temperature are within expected ranges. Thus a mode of operation may be used where the module only need acquire a few, or even single, frames at a time, leading to power on times of less than a second if no deviations are observed. The result may be very low power consumption and very long battery life.

One method embodiment of the shutter-based technique is shown in FIG. 12. In step 90 the imager (module) is powered up at intervals long enough for the FPA and shutter and other elements to reach thermal equilibrium. In step 91, one or at most a few frames of data are taken with the shutter closed. In step 92, the image is powered down for a period long enough to reach equilibrium, and one or at most a few frames of shutter open data are taken. In step 93 the data is analyzed to determine if any region has deltas between the shutter open and closed frames that exceeds predetermined thresholds. In step 94, any deviations are reported and acted on and in step 95 the steps are repeated. In FIG. 13, a similar process is shown, with the shutter open and shutter closed frames taken on the same power up cycle.

### Example Embodiments

1. A monitoring system comprising:
a thermal imager;
a visible imager;
a local processor in communication with the thermal imager and the visible imager; and
a network connection in communication with the processor and configured to communicate with a remote server;
wherein the local processor and the remote server execute applications configured to share, between the local processor and the remote server, acquisition of camera video data from the cameras, and
wherein the monitoring system is configured to monitor one or more temperature, pressure, gas, ozone, particulate, or smoke sensors disposed local to the visible imager.

2. The monitoring system of embodiment 1 wherein the network connection comprises at least one of:
a wired or wireless connection to a proprietary network;
a wired connection to the internet; or
a wireless connection to an internet bridge, wherein the internet bridge comprises at least one of a wired connection to an internet gateway or a wireless connection to a router, the router being connected to an internet gateway.

3. The monitoring system of embodiment 2, wherein the network connection comprises a powered Ethernet connection.

4. The monitoring system of embodiment 1, further comprising a standard local bus controller and bus interface including at least one of I²C, USB, PCI, or Firewire.

5. The monitoring system of embodiment 4, wherein the bus controller and the bus interface are compatible with off-the-shelf devices including sensors and actuators.

6. The monitoring system of embodiment 1, wherein the network connection includes at least one of Bluetooth, Zigbee, wi-fi, cellular, satellite telephone, or optical.

7. The monitoring system of embodiment 1, wherein the visible imager and the thermal imager are installed within a single camera module, installed within separate camera modules, or a combination thereof.

8. The monitoring system of embodiment 7, wherein the off-the shelf devices include: accelerometers, magnetic sensors, linear actuators, motors, A/D converters, barometers, fluid level sensors, current/power sensors, linear position sensors and actuators, flow sensors, pressure sensors, gas sensors, optical motion sensors, temperature sensors, optical position sensors, vibration/acoustic sensors, proximity sensors, audio alarms, visual alarms, visual status indicators, valve controllers, switch controllers, I/O breakout modules, and illumination controllers.

9. The monitoring system of embodiment 1 wherein the monitoring system is configured to remain operational in a dangerous high temperature condition an industrial environment.

10. The monitoring system of embodiment 1, wherein devices interfaced to the local bus are accessible from applications executing on at least one of the local processor or the server.

11. The monitoring system of embodiment 1, wherein the system is configured to monitor electrical cabinet components.

12. The monitoring system of embodiment 1 wherein data collected by the local processor is archived by the remote server over an extended time period, such that when an abnormal condition is detected in image data, previous thermal data associated with potential abnormal conditions is available.

13. The monitoring system of embodiment 1 wherein the system is configured to bowered by an independent power source comprising a battery or a solar power source.

14. The monitoring system of embodiment 11 wherein the at least one visible light cameras is further configured to image external surfaces of operating equipment.

15. The monitoring system of embodiment 1 wherein at least one camera is installable in an existing environment without requiring infrastructure changes.

16. The monitoring system of embodiment 1 wherein location or orientation information relative to the cameras is included in data provided to the server.

17. A thermal monitoring system comprising:
at least one thermal camera;
at least one local processor in communication with the thermal camera;
at least one visible light camera configured to image gauges, wherein the visible camera is in communication with the at least one local processor; and
at least one network connection in communication with the processor and configured to communicate with a remote server;
wherein the local processor and the remote server execute applications configured to share, between the local processor and the remote server, acquisition of camera video data from the cameras, and at least part of the system is configured to be operable at temperatures of at least one of 55 degrees or lower C, 65° C. or lower or 75° C. or lower.

18. The monitoring system of embodiment 17 wherein the network connection comprises at least one of:
a wired or wireless connection to a proprietary network;
a wired connection to the internet; or
a wireless connection to an internet bridge, wherein the internet bridge comprises at least one of a wired connection to an internet gateway or a wireless connection to a router, the router being connected to an internet gateway.

19. The monitoring system of embodiment 18, wherein the network connection comprises a powered Ethernet connection.

20. The monitoring system of embodiment 17, further comprising a standard local bus controller and bus interface including at least one of I²C, USB, PCI, or Firewire.

21. The monitoring system of embodiment 17, wherein the network connection includes at least one of Bluetooth, Zigbee, wi-fi, cellular, satellite telephone, or optical.

22. The monitoring system of embodiment 17, wherein the visible cameras and thermal cameras are at least one of packaged and installed together, packaged and installed separately, or a combination thereof.

23. The monitoring system of embodiment 20, wherein the bus controller and the bus interface are compatible with off-the-shelf devices including sensors and actuators.

24. The monitoring system of embodiment 23, wherein the off-the shelf devices include: visible cameras, accelerometers, magnetic sensors, linear actuators, motors, A/D converters, barometers, fluid level sensors, current/power sensors, linear position sensors and actuators, flow sensors, pressure sensors, gas sensors, optical motion sensors, temperature sensors, optical position sensors, vibration/acoustic sensors, proximity sensors, audio alarms, visual alarms, visual status indicators, valve controllers, switch controllers, I/O breakout modules, and illumination controllers.

25. The monitoring system of embodiment 17 wherein the operating temperature range is achieved by a combination of packaging design, component selection and image processing

26. The monitoring system of embodiment 17, wherein devices interfaced to the local bus are accessible from applications executing on at least one of the local processor or the server.

27. The monitoring system of embodiment 17, wherein the system is configured to monitor high power electrical components in at least one cabinet.

28. The monitoring system of embodiment 27, wherein high voltage components are mounted in one cabinet region and lower voltage components including gauges are mounted in another electrically connected cabinet region, and the thermal camera is mounted in the high voltage cabinet region and at least one visible camera is mounted in the low voltage cabinet region.

29. The monitoring system of embodiment 27 wherein the system further comprises additional sensors including gas detectors, smoke detectors, ultrasonic detectors or spark flash detectors.

30. The monitoring system of embodiment 17 wherein data collected by the local processor is archived by the server in time windows, such that when a triggering event is detected in image data, information leading up to the trigger event is available.

31. The monitoring system of embodiment 17 wherein the system is powered independently of a local power source, including powered by battery or dedicated solar array.

32. The monitoring system of embodiment 17 wherein the network connection is independent of local connectivity, including connecting by system dedicated cell modem.

33. The monitoring system of embodiment 27 wherein the at least one visible light cameras is further configured to image equipment name plates

34. The monitoring system of embodiment 17 wherein at least one camera is mountable by way of a magnetic or adhesive mount to minimize infrastructure changes.

35. The monitoring system of embodiment 17 wherein rotational information relative to the cameras is included in data provided to the server.

36. A method for operating a monitoring system for high power electrical distribution equipment, the method comprising:
mounting at least one thermal camera configured to operate at ambient temperature as high as at least one of 55° C., 65° C., or 75° C. in a position to view temperature critical components;
mounting at least one visible light camera in a position to view gauges;
interfacing the cameras to a local processor for at least one of image capture or image processing of the cameras' image data;
connecting the local processor by way of a network interface to a remote network server; and

reporting information related to camera image capture to the remote server.

The embodiments described herein are exemplary. Modifications, rearrangements, substitute devices, processes, etc. may be made to these embodiments and still be encompassed within the teachings set forth herein. One or more of the steps, processes, or methods described herein may be carried out by one or more processing and/or digital devices, suitably programmed. One or more of the electronic, optical, and other system components may be replaced with alternate elements.

Depending on the embodiment, certain acts, events, or functions of any of the processes described herein can be performed in a different sequence, can be added, merged, or left out altogether (e.g., not all described acts or events are necessary for the practice of the process). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and method steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. For example, the configuration data described herein may be implemented using a discrete memory chip, a portion of memory in a microprocessor, flash, EPROM, or other types of memory.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instructions.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so of the elements in the list.

Disjunctive language such as the phrase that when used, for example, to connect a list of elements, the term “or” means one, some, or all. The phrase “at least one of X, Y or Z,” unless specifically stated otherwise, is understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or processes illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A method for thermal monitoring of a FOV utilizing one or more networked interfaced, thermal imaging modules capable of operating in low power quiescent and active modes, including a shutter and a thermal sensor, comprising:
a. waking up the imaging module on at least one of a periodic time interval or in response to a wake-up command received over the network, wherein that interval is of sufficient time for the thermal sensor and shutter to reach thermal equilibrium substantially at room temperature;
b. acquiring at least one of at least one frame of image data with the shutter closed, at least one frame with the shutter open, or both shutter open and shutter closed frames of at least a portion of the FOV;
c. segmenting the image of the scene into at least two regions;
d. determining if intensity of a region from a shutter open frame exceeds a predetermined difference from the intensity of the region with the shutter closed corresponding to a difference from room temperature and if so, at least one of; sending at least one of an alert or region temperature data over the network interface, or; sending a scene thermal image over the network interface; and
e. returning to low power mode and repeating steps a-d.
